(19) United States
(12) Patent Application Publication
(10) Pub. No.: US 2005/0134026 A1
(43) Pub. Date: Jun. 23, 2005

(54) Curtain airbag device

(75) Inventors: Masayoshi Kumagai, Ika-gun (JP); Atsushi Noguchi, Moriyama-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/010,412

(22) Filed: Dec. 14, 2004

(30) Foreign Application Priority Data
Dec. 19, 2003 (JP) 2003-423067

(51) Int. Cl. B60R 21/22

(52) U.S. Cl. 280/730.2; 280/743.2

(57) ABSTRACT

A curtain airbag device and a guide unit allow quick deployment of a curtain airbag. When an inflator is activated, the curtain airbag is deployed downward along a vehicle interior side of a pillar garnish. During the deployment, the rear portion of the curtain airbag is guided by a guide rod via a link strap. The curtain airbag is provided with a first vertical chamber extending along the guide rod from the upper edge to the lower edge of the curtain airbag. A center line C of the first vertical chamber is substantially parallel to the guide rod.

### BACKGROUND

The present invention relates to curtain airbag devices provided with curtain airbags which are capable of being deployed along inner side surfaces of vehicle cabins.

In a vehicle provided with a curtain airbag device, when the vehicle is involved in, for example, a side-on collision or rollover, curtain airbags are deployed downward along an inner side surface (for example, a door and a pillar) of the vehicle cabin so as to protect the head of the vehicle occupant and to keep the vehicle occupant inside the vehicle cabin.

U.S. Pat. No. 6,237,938 discloses a guide member provided on a C pillar for guiding downward (along the pillar) a rear portion of a curtain airbag, which is inflatable along the inner side surface of the vehicle cabin.

Moreover, the guide member in U.S. Pat. No. 6,237,938 includes truck having a box-shaped cross-section and a slider called an element that is movably arranged in the track in the longitudinal direction of the track. The rear end portion of the curtain airbag is tied to the element. To prevent the rear edge portion of the curtain airbag, which is moved downward, from being returned upward, latches are arranged at regular intervals along substantially the entire length of the track. The top and bottom ends of the track are provided with mounting flanges, and each of the flanges is fixed to the C pillar with a bolt or a screw. Unfortunately, however, this arrangement can complicate the deployment of the curtain airbag such that the deployment may not be smooth.

Accordingly, the present invention has been made in light of the aforementioned problems. It is an object of the present invention to provide a curtain airbag device in which a curtain airbag is capable of being deployed very smoothly along a guide member.

### SUMMARY

An embodiment of the invention addresses a curtain airbag device that includes, among other possible things; (a) a curtain airbag that is capable of being deployed downward along an inner side surface of a vehicle cabin; and (b) a guide member attached to a pillar of a vehicle and extending vertically for guiding the curtain airbag for the downward deployment. The curtain airbag includes a vertical chamber that is inflatable along the guide member from an upper portion to a lower portion of the curtain airbag. The vertical chamber is disposed substantially directly above a base end of a link strap. A vertical line connecting middle points in the width direction of the vertical chamber is substantially parallel to the guide member.

In a further embodiment of the curtain airbag device, the link strap may protrude from a lower end portion of the vertical chamber of the curtain airbag and may be guided by the guide member. According to such a structure, when the vertical chamber is inflated substantially vertically downward, the link strap can smoothly move downward as it is pulled by the lower end portion of the vertical chamber.

In another further embodiment of the curtain airbag device, the guide member may extend within a range of ±20° with respect to a vertical line of the vehicle cabin.

Another embodiment of the invention addresses a curtain airbag device that includes, among other possible things: (a) a curtain airbag that is configured to be installed along an inner side surface of a vehicle cabin, and that is configured for downward deployment; and (b) a guide member that is configured to be vertically attached to a pillar of a vehicle, and that is configured to guide the curtain airbag during the downward deployment. The curtain airbag includes a vertical chamber that is configured to be inflated along the guide member from an upper portion to a lower portion of the curtain airbag. A vertical line connecting middle points in a width direction of the vertical chamber is substantially parallel to the guide member.

In a further embodiment of the curtain airbag device, the curtain airbag device may also include a link strap. Further, the vertical chamber may be disposed substantially directly above a base end of a link strap.

In another further embodiment of the curtain airbag device, the link strap may protrude from a lower portion of the vertical chamber.

In another further embodiment of the curtain airbag device, the link strap may be configured to guide the vertical chamber along the guide member when the vertical chamber is inflated.

In another further embodiment of the curtain airbag device, the guide member may extend within a range of ±20° with respect to a vertical line of the vehicle cabin.

In another further embodiment of the curtain airbag device, the guide member and the vertical line connecting middle points in a width direction of the vertical chamber may be oriented with an angle of ±5° with respect to each other.

Another embodiment of the invention addresses a vehicle that includes, among other possible things: (a) a vehicle cabin; and (b) a curtain airbag device. The curtain airbag device includes, among other possible things: (i) a curtain airbag installed along an inner side surface of the vehicle cabin, wherein the curtain airbag is configured for downward deployment; and (ii) a guide member that is vertically attached to a pillar of the vehicle, wherein the guide member is configured to guide the curtain airbag during the downward deployment. The curtain airbag includes a vertical chamber that is configured to be inflated along the guide member from an upper portion to a lower portion of the curtain airbag. A vertical line connecting middle points in a width direction of the vertical chamber is substantially parallel to the guide member.

In a further embodiment of the vehicle, the vehicle may include a link strap. The vertical chamber may be disposed substantially directly above a base end of a link strap.

In another further embodiment of the vehicle, the link strap may protrude from a lower portion of the vertical chamber.

In another further embodiment of the vehicle, the link strap may be configured to guide the vertical chamber along the guide member when the vertical chamber is inflated.

In another further embodiment of the vehicle, the guide member may extend within a range of ±20° with respect to a vertical line of the vehicle cabin.

In another further embodiment of the vehicle, the guide member and the vertical line connecting middle points in a width direction of the vertical chamber may be oriented with an angle of ±5° with respect to each other.

According to the curtain airbag device of the present invention, as the vertical chamber and the guide member are substantially parallel to each other, the vertical chamber can be inflated quickly along the guide member when the curtain airbag is deployed. Thus, the curtain airbag can be deployed very quickly while being guided by the guide member.

According to the curtain airbag device of the present invention, when the curtain airbag is to be deployed, the curtain airbag is guided by the guide member and the vertical chamber disposed near the guide member of the curtain airbag is quickly inflated downward so as to allow rapid deployment of the curtain airbag.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows an un-inflated curtain airbag device according to an embodiment of the present invention that extends along a roof side of a vehicle; a guide rod is disposed along a C pillar;

FIG. 2 is an enlarged view of a rear portion of the curtain airbag of FIG. 1 in an inflated state; and

FIG. 3(a) provides a side view and FIG. 3(b) provides a cross-sectional view of the curtain airbag of FIG. 1 in an inflated state taken along line B-B in FIG. 3(a).

### DETAILED DESCRIPTION

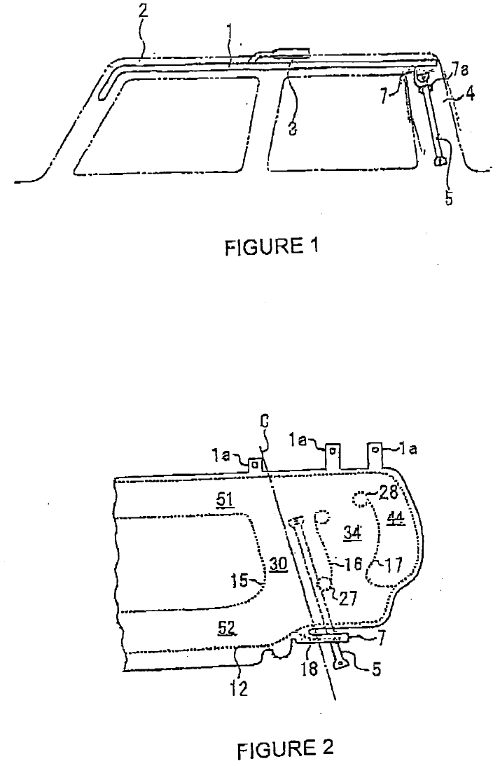

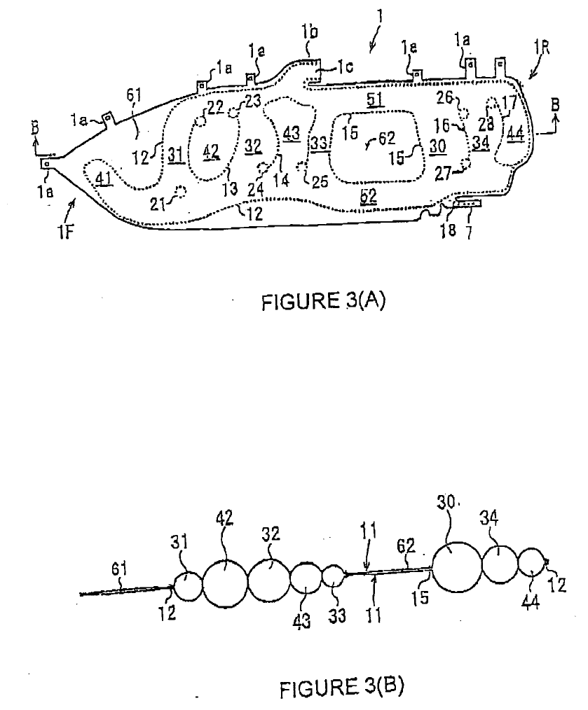

Embodiments of the present invention will be described herein with reference to the drawings. FIG. 1 shows a curtain airbag device according to an embodiment, of the present invention. The diagram illustrates (a) a curtain airbag that extends along a roof side of a vehicle and (b) a guide rod that is disposed along a C pillar. FIG. 2 is an enlarged view of a rear portion of the curtain airbag of FIG. 1 in an inflated state. FIG. 3(a) is a side view illustrating a state where the curtain airbag is inflated. FIG. 6(b) is a cross-sectional view taken along line B-B in FIG. 3(a).

According to the shown embodiment of the invention, curtain airbags 1 are disposed along a roof side 2 of a vehicle (the border section between the ceiling and inner side surface of a vehicle cabin) while being folded in a slender manner in the longitudinal direction of the vehicle. When the vehicle is involved in a collision (e.g., a side-on collision) or a rollover, for example, the curtain airbag 1 is inflated by gas being sent from an inflator 3 and is deployed in the downward direction of the vehicle body along the side surface, i.e. doors and pillars, in the vehicle cabin. An upper edge of the curtain airbag 1 is provided with tabs 1a (see FIG. 3(a)) which are fastened to the corresponding roof side 2.

With reference to FIGS. 3(a) and 3(b), the central portion of the upper edge of the curtain airbag 1, with respect to the longitudinal direction of the airbag 1, is provided with a projection 1b that extends upward. The projection 1b is provided with a gas-entrance hole 1c. A tip of the inflator 3 is inserted through the gas-entrance hole 1c and is tied thereto with a band (not shown).

With reference to FIG. 1, a C pillar 4 in the vehicle has a guide rod 5 attached thereto. The guide rod 5 functions as a guide member for guiding the rear portion of the curtain airbag 1 along the C pillar 4 when the curtain airbag 1 is deployed along the C pillar 4 in the downward direction of the vehicle body. The guide rod 5 is a rod-like structure that extends along the C pillar 4 in a generally vertical direction with respect to the vehicle body. Both the upper and lower ends of the guide rod 5 are fixed to the C pillar 4 with, for example, bolts.

Furthermore, a pillar trim or garnish (not shown) covers the cabin-side of the C pillar 4. The door-frame portion of the C pillar 4 has a weather strip (not shown) attached thereto. A lateral edge of the pillar garnish is in contact with the weather strip. The roof side 2 is provided with a roof-side garnish (not shown) that covers the curtain airbag 1. The roof-side garnish abuts against the pillar garnish.

As shown in FIG. 3, the curtain airbag 1 is formed by overlapping two sheets 11, 11 having substantially the same shape, such that one of the sheets faces an inner side surface of the vehicle cabin and the other faces the interior of the vehicle cabin. The two sheets 11, 11 are connected to each other by connected portions 12-18 and circular connected portions 21-28 so as to form a first vertical chamber 30, vertical chambers 31-34, bag chambers 41-44, horizontal chambers 51, 52, and non-inflatable portions 61, 62. Each of the connected portions 12-17, 21-28 may be, for example, lines of stitching.

A link strap 7 protrudes from a rear portion of the curtain airbag 1 in the vicinity of a bottom corner thereof. Specifically, the link strap 7 positioned below the first vertical chamber 30 of the curtain airbag 1. Further, the link strap 7 is formed by extending the sheets 11 and 11 in an elongated shape and joining them together by the connected portion 18, which is later described in detail. An extremity of the link strap 7 is provided with a loop 7a (shown in FIG. 1) that is loosely tied around the guide rod 5. The loop 7a is movable vertically along the guide rod 5. Alternatively, the extremity of the link strap 7 may be provided with a ring (not shown), the ring being set around the guide rod 5.

The connected portions 12-18 and the circular connected portions 21-28 hermetically join the sheets 11, 11 together. For the connection between the two sheets 11, 11, high-strength connecting means (such as stitching with high-strength threads, bonding with an adhesive having high adhesivity, or welding) may be used so that the two sheets 11, 11 are unable to separate from each other even when the pressure inside the curtain airbag 1 reaches the upper limit pressure value.

The connected portion 12 extends substantially around the curtain airbag 1, but at a front portion 1F of the curtain airbag 1, the connected portion 12 extends downward from the upper edge of the front portion 1F so as to form a substantially U-shape. This forms the non-inflatable portion 61 along the upper edge of the front portion 1F and the bag chamber 41 at the frontmost part of the front portion 1F.

The connected portion 12 extends along an edge of the projection 1b of the curtain airbag 1, but is interrupted at the rear edge of the projection 1b so as to form the gas-entrance hole 1c of the curtain airbag 1.

The connected portion 13 is disposed slightly towards the front of the curtain airbag 1 with respect to the center of the curtain airbag 1. The connected portion 13 is U-shaped, and its inner region forms the bag chamber 42. The upper portion of the bag chamber 42 communicates with the gas-entrance hole 1c, whereas the lower portion has no openings.

The connected portion 13 and the peripheral connected portion 12 at the front portion 1F of the curtain airbag 1 have the vertical chamber 31 disposed therebetween. The upper portion of the vertical chamber 31 communicates with the gas-entrance hole 1c, and the lower portion communicates with the bag chamber 41 and with the lower portion of the vertical chamber 32, which will later be described in detail. To prevent the lower portion of the vertical chamber 31 from being over-inflated, the circular connected portion 21 is provided.

The connected portion 14 has an inverted U-shape and is disposed at the central portion of the curtain airbag 1 with respect to the longitudinal direction of the airbag 1. The inner region of the connected portion 14 forms the bag chamber 43. The lower portion of the bag chamber 43 communicates with the lower portions of the vertical chambers 32 and 33, whereas the upper portion of the bag chamber 43 has no openings.

The connected portion 14 and the connected portion 13 have the vertical chamber 32 disposed therebetween. The upper portion of the vertical chamber 32 communicates with the gas-entrance hole 1c.

The connected portion 15 is disposed slightly towards the back of the curtain airbag 1 with respect to the center of the curtain airbag 1. The connected portion 15 is substantially square-shaped. The upper edge and the lower edge of the connected portion 15 are respectively not in contact with the upper edge and the lower edge of the connected portion 12. Thus, the horizontal chamber 51 is formed between the upper edge of the connected portion 12 and the upper edge of the connected portion 15, and the horizontal chamber 52 is formed between the lower edge of the connected portion 12 and the lower edge of the connected portion 15.

The connected portion 15 and the connected portion 14 have the vertical chamber 33 disposed therebetween. The upper portion of the vertical chamber 33 communicates with the front portion of the horizontal chamber 51 and with the gas-entrance hole 1c. The lower portion of the vertical chamber 33 communicates with the lower portion of the bag chamber 43 and the front portion of the horizontal chamber 52.

The inner region of the connected portion 15 is cut off from the gas-entrance hole 1c so as to form the non-inflatable portion 62.

At the rear portion of the curtain airbag 1, the connected portion 16 is disposed and extends generally vertically. Moreover, further towards the back of the curtain airbag 1, the connected portion 17 having a generally L-shape is disposed.

The connected portions 15 and 16 have the first vertical chamber 30 disposed therebetween. The upper and lower portions of the first vertical chamber 30 respectively communicate with the horizontal chambers 51 and 52.

The connected portions 16 and 17 have the vertical chamber 34 disposed therebetweem. The upper and lower portions of the vertical chamber 34 respectively communicate with the upper and lower portions of the first vertical chamber 30. Alternatively, the vertical chamber 34 may be bag-shaped such that only the lower portion communicates with the lower portion of the first vertical chamber 30.

The bag chamber 44 is formed between the connected portion 17 and a part of the connected portion 12 extending along a rear portion 1R of the curtain airbag 1. The upper portion of the bag chamber 44 communicates with the upper portion of the vertical chamber 34, whereas the lower portion of the bag chamber 44 has no openings. Alternatively, the lower portion of the bag chamber 44 may communicate with the lower portion of the vertical chamber 34.

Both ends of each of connected portions 13, 14, and 16, are provided with circular connected portions 22-27 for reinforcement. An upper end of connected portion 17 is provided with a circular connected portion 28, whereas the lower end of the connected portion 17 is connected with the connected portion 12.

With reference to FIGS. 2 and 3, the rear edge of the connected portion 15 extends substantially vertically. The first vertical chamber 30 is formed between the rear edge of the connected portion 15 and the connected portion 16 extending vertically. The first vertical chamber 30 extends from the upper edge to the lower edge of the curtain airbag 1. A line (center line) C, which is formed by connecting the middle points in the longitudinal width direction of the first vertical chamber 30, is substantially parallel to the guide rod 5. In other words, if the guide rod 5 is traced over the curtain airbag 1, the line C and the guide rod 5 are positioned within an angle of ±5° with respect to each other.

In this embodiment, the longitudinal line of the guide rod 5 and the line C are both titled so that the upper portions are closer to the front of the vehicle body than the lower portions. Alternatively, the upper portions may be titled so that the upper portions are closer to the back of the vehicle body. The angle of incline in both cases is preferably within a range of ±20° with respect to a vertical line of the vehicle body.

The vertical chambers 31 to 34 similarly extend from the upper edge to the lower edge of the curtain airbag 1.

When a vehicle provided with such a curtain airbag device is involved in a side-on collision or a rollover, the inflator 3 generates gas so as to inflate the curtain airbag 1. The curtain airbag 1 pushes open the roof-side garnish, and is deployed downward along the vehicle interior side of the pillar garnish.

The rear portion of the deploying curtain airbag 1 is guided by the guide rod via the link strap 7. The link strap 7 starts moving downward along the guide rod 5 when the curtain airbag 1 begins to be deployed. In this case, as the curtain airbag 1 is being deployed the link strap 7 moves downward while ripping through the pillar garnish and the weather strip.

Furthermore, the link strap 7 moves downward along the guide rod 5 with the curtain airbag 1 until the curtain airbag 1 reaches the bottommost point of deployment. As the link strap 7 connects the curtain airbag 1 and the guide rod 5 together, the curtain airbag 1 can be deployed along the corresponding side surface of the vehicle cabin.

According to the above embodiment, the center line C of the first vertical chamber 30 and the guide rod 5 are substantially parallel with each other. As a result, the direction of deployment of the first vertical chamber 30 is aligned with the direction in which the guide rod 5 extends. The first vertical chamber 30 can thus be quickly inflated downward. Accordingly, the curtain airbag 1 is capable of being deployed quickly along the guide rod 5.

As the center line C of the first vertical chamber 30 and the guide rod 5 are tilted towards the front of the vehicle body, a strong tension is generated in the horizontal direction along the lower edge of the curtain airbag 1 when the curtain airbag 1 is deployed. This includes a state in which the lower edge of the curtain airbag 1 is pulled sideways with a strong force. Accordingly, such a curtain airbag 1 provides a high restraining force for keeping vehicle occupants inside a vehicle. In other words, the curtain airbag 1 advantageously prevents vehicle occupants from being thrown outside a vehicle.

The technical scope of the present invention is not limited to the above embodiment and modifications are permissible within the scope and spirit of the present invention. For example, the number and positions of the vertical chamber and the bag chambers are not limited to those in the drawings. The guide rod may alternatively be provided along a D pillar.

The priority application, Japanese Application 2003-423067, which was filed Dec. 19, 2003, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A curtain airbag device comprising:
a curtain airbag that is capable of being deployed downward along an inner side source of a vehicle cabin; and
a guide member attached to a pillar of a vehicle and extending vertically for guiding the curtain airbag for the downward deployment,
wherein the curtain airbag includes a vertical chamber that is inflatable along the guide member from an upper portion to a lower portion of the curtain airbag,
wherein the vertical chamber is disposed substantially directly above a base end of a link strap, and
wherein a vertical line connecting middle points in a width direction of the vertical chamber is substantially parallel to the guide member.

2. The curtain airbag device according to claim 1, wherein the link strap, which protrudes from a lower portion of the vertical chamber of the curtain airbag, is guided by the guide member.

3. The curtain airbag device according to claim 2, wherein the guide member extends within a range of ±20° with respect to a vertical line of the vehicle cabin.

4. A curtain airbag device comprising:
a curtain airbag that is configured to be installed along an inner side surface of a vehicle cabin, and that is configured for downward deployment; and
a guide member that is configured to be vertically attached to a pillar of a vehicle, and that is configured to guide the curtain airbag during the downward deployment,
wherein the curtain airbag includes a vertical chamber that is configured to be inflated along the guide member from an upper portion to a lower portion of the curtain airbag and
wherein a vertical line connecting middle points in a width direction of the vertical chamber is substantially parallel to the guide member.

5. The curtain airbag device according to claim 4, further comprising:
a link strap,
wherein the vertical chamber is disposed substantially directly above a base end of a link strap.

6. The curtain airbag device according to claim 5, wherein the link strap protrudes from a lower portion of the vertical chamber.

7. The curtain airbag device according to claim 5, wherein the link strap is configured to guide the vertical chamber along the guide member when the vertical chamber is inflated.

8. The curtain airbag device according to claim 4, wherein the guide member extends within a range of ±20° with respect to a vertical line of the vehicle cabin.

9. The curtain airbag device according to claim 4, wherein the guide member and the vertical line connecting middle points in a width direction of the vertical chamber are oriented with an angle of ±5° with respect to each other.

10. A vehicle comprising:
a vehicle cabin; and
a curtain airbag device comprising:
a curtain airbag installed along an inner side surface of the vehicle cabin, wherein the curtain airbag is configured for downward deployment, and
a guide member that is vertically attached to a pillar of the vehicle, wherein the guide member is configured to guide the curtain airbag during the downward deployment,
wherein the curtain airbag includes a vertical chamber that is configured to be inflated along the guide member from an upper portion to a lower portion of the curtain airbag, and
wherein a vertical line connecting middle points in a width direction of the vertical chamber is substantially parallel to the guide member.

11. The vehicle according to claim 10, further comprising:
a link strap,
wherein the vertical chamber is disposed substantially directly above a base end of a link strap.

12. The vehicle according to claim 11, wherein the link strap protrudes from a lower portion of the vertical chamber.

13. The vehicle according to claim 11, wherein the link strap is configured to guide the vertical chamber along the guide member when the vertical chamber is inflated.

14. The vehicle according to claim 10, wherein the guide member extends within a range of ±20° with respect to a vertical line of the vehicle cabin.

15. The vehicle according to claim 10, wherein the guide member and the vertical line connecting middle points in a width direction of the vertical chamber are oriented with an angle of ±5° with respect to each other.
